(19) United States
(12) Patent Application Publication
(10) Pub. No.: US 2010/0018941 A1
(43) Pub. Date: Jan. 28, 2010

(54) METHOD AND APPARATUS FOR VERIFYING SEAL INTEGRITY

(75) Inventors: David Kerr, Loughborough (GB); Robert Parkin, Barrow Upon Soar (GB); Michael Jackson, Stoney Stanton (GB); Neil Brown, Leicester (GB); Fangmin Shi, Loughborough (GB)

Correspondence Address: CHERNOFF, VILHAUER, MCCLUNG & STENZEL, LLP, 601 SW Second Avenue, Suite 1600, Portland, OR, 97204, US

(73) Assignee: LOUGHBOROUGH UNIVERSITY ENTERPRISES LIMITED, Loughborough, Leicestershire (GB)

(21) Appl. No.: 11/721,663

(22) PCT Filed: Dec. 14, 2005
(86) PCT No.: PCT/GB2005/004836

§ 371 Date: Jun. 10, 2008

(30) Foreign Application Priority Data
Dec. 14, 2004 (GB) 0427321.5

(51) Int. Cl. B65D 41/00; H04N 7/18

(52) U.S. Cl. 215/250; 382/143; 348/89; 382/190; 348/E07.085

(57) ABSTRACT

A method of verifying the integrity of a seal in a sealing region between a container and a sealing film applied to the container comprises viewing at least the sealing region to detect the presence of a detectable predetermined feature in the sealing region. The presence of the detectable predetermined feature in the sealing region is indicative of an improper seal between the container and the sealing film whilst the absence of the detectable predetermined feature in the sealing region is indicative of an integral seal between the container and the sealing film.

Embodiments of the present invention relate to a method and apparatus for verifying the integrity of a seal, and/or a method of sealing material in a container and/or a container sealed by said method and/or a container assembly.

The popularity of pre-prepared and pre-packaged food items has increased significantly during recent years, and such items are usually supplied in disposable plastics containers sealed, for example, using a single or multiple layer plastics sealing film. An automated process involving the application of heat and pressure is conventionally employed to seal the container by bonding the sealing film to the container.

The formation of an integral seal between the sealing film and the container is important for a number of reasons. Firstly, an integral seal is desirable to prevent the entry of oxygen or contaminating agents into the sealed containers in order to maximise the shelf-life of pre-packaged food items. Secondly, an integral seal is desirable to prevent leakage of food items from the sealed containers, for example when on display when the containers are sometimes placed on their side, or during transportation. Consequently, any discontinuities in the seal are undesirable.

Currently, the integrity of the seal formed between the container and the sealing film is verified by production operatives manually testing the seal. However, it can be difficult and time consuming to verify seal integrity in this way, and thus the seal integrity of only a selected sample of containers of a production run would normally be verified.

If it transpires that the integrity of one or more of the seals of the selected sample of containers is unsatisfactory, that is to say that the seal between the container and the sealing film is not integral, it may be necessary to reject all of the other sealed containers which were produced in the same production run. This can result in the waste of a significant amount of food and significantly increase the cost of producing the pre-packaged food items.

It would be desirable to address the disadvantages associated with the known technique for verifying seal integrity.

According to a first aspect of the present invention, there is provided a method of verifying the integrity of a seal in a sealing region between a container and a sealing film applied to the container, the presence of a detectable predetermined feature in the sealing region being indicative of an improper seal between the container and the sealing film, and the absence of a detectable predetermined feature being indicative of an integral seal between the container and the sealing film, the method comprising viewing at least the sealing region to detect the presence or absence of the predetermined feature in the sealing region.

The predetermined feature may be a feature, for example an aspect of surface configuration, of the container and/or of the sealing film. The predetermined feature may be an aspect of minor surface relief compared to the overall dimensions of the container.

The predetermined feature may be defined by material applied to the surface of the container and/or the sealing film in the sealing region. The material may be applied for example using a laser jet or an ink jet printing technique to provide surface projections.

The predetermined feature may comprise the absence of material from the surface of the container and/or the sealing film in the sealing region. The absence of material may form indentations. The indentations may be formed during manufacture of the container and/or the sealing film. Alternatively, the indentations may be formed by removal, for example by ablation, of material from the surface of the container and/or the sealing film.

The use of the predetermined feature according to the invention is advantageous since it allows automated processing to verify seal integrity using the above method. However, it is to be understood that manual processing to verify seal integrity may alternatively be employed.

In particular, the predetermined feature may have some aspect of repeatability. For example, the predetermined feature may comprise a plurality of spaced indentations or surface projections and the spacing between the indentations or projections may have a predetermined periodicity. Alternatively, a characteristic of the indentations or projections may be predetermined, for example the width of the indentations or projections.

The predetermined feature may for example be a repeat pattern and may repeat at intervals of up to 2 mm, and more preferably at intervals of up to 1 mm. The repeat interval may allow the integrity of the seal to be verified over that interval, and may be selected to enable automated processing using a digital signal processing technique.

According to a second aspect of the present invention, there is provided a method of verifying the integrity of a seal in a sealing region between a container and a sealing film applied to the container, the presence of a detectable predetermined feature in the sealing region being indicative of an improper seal between the container and the sealing film, the method comprising viewing at least the sealing region to detect the presence of the predetermined feature in the sealing region.

The step of viewing at least the sealing region may comprise viewing the entire sealing region to detect the presence of the predetermined feature at any portion of the sealing region.

The step of viewing the sealing region may comprise viewing the sealing region using the human eye.

The step of viewing the sealing region may comprise capturing an image of the sealing region using an image capture means. The step of viewing the sealing region may comprise capturing an image of the container and the sealing region, and extracting the image of the sealing region.

The method may comprise processing the captured image to detect the presence of the predetermined feature at any portion of the sealing region. Where the predetermined feature has a known period, the processing step may comprise processing the captured image to detect the existence of the known period in the image. Where the predetermined feature has a predetermined characteristic signal spectrum, the processing step may comprise processing the captured image to detect the presence of the predetermined characteristic signal spectrum. A fast Fourier transform or a Wavelet transform may be used to perform the processing step.

The processing step may be provided by a computer program.

The method may comprise providing an alert in response to the detection of the known period or the predetermined characteristic signal spectrum by the processing step.

According to a third aspect of the present invention, there is provided apparatus for verifying the integrity of a seal in a sealing region between a container and a sealing film applied to the container, the presence of a detectable predetermined feature in the sealing region being indicative of an improper seal between the container and the sealing film, the apparatus comprising image capture means for capturing an image of at least the sealing region and a processor for processing the captured image to detect the presence of a predetermined feature in the sealing region.

The image capture means may include a camera operable to capture an image of the sealing region. The camera may be a line scan camera.

The apparatus may include illumination means for illuminating the container in at least the sealing region.

The processor may be operable to analyse the image captured by the camera to detect the presence of the predetermined feature in the image.

The apparatus may be used to perform the method according to the first or second aspects of the present invention.

According to a fourth aspect of the present invention, there is provided a method of sealing material in a container, the container including a cavity portion for receiving material and a peripheral sealing region, the method comprising applying a sealing film to the container in the sealing region to cover the cavity portion, and sealing the container by bonding the sealing film to the peripheral sealing region, wherein a detectable predetermined feature at a portion of the sealing region indicates an improper bond between the container and the sealing film.

The method may comprise locating material in the cavity portion of the container prior to applying the sealing film. The step of applying the sealing film may comprise urging the sealing film and the container towards each other.

The method may comprise heating the container in the peripheral sealing region prior to applying the sealing film to soften the container material.

The bonding step may comprise causing melting of an adhesive on the sealing film and subsequently allowing curing of the adhesive. Alternatively or in addition, the bonding step may comprise causing localised melting of the container and/or the sealing film and subsequently allowing curing thereof.

The bonding step may comprise heating and/or applying a force to the sealing film and the container in the peripheral sealing region. The bonding step may comprise heating and/or applying the force for a predetermined time period. The bonding step may comprise heating to a predetermined temperature and may comprise applying a predetermined force.

A sealing head may be used to heat and/or apply the force to the sealing film and the container, and the bonding step may comprise pressing the sealing head against the sealing film and activating a heating element to heat the sealing head. A laser may alternatively be used to heat the sealing film and/or the container in the peripheral sealing region, and the bonding step may comprise activating the laser and sweeping the activated laser around the peripheral sealing region.

The method may comprise trimming the bonded sealing film after bonding to the container so that there is substantially no overlap of sealing film beyond the peripheral sealing region.

The method may comprise verifying the integrity of the seal in the sealing region between the container and the sealing film bonded to the container. The step of verifying the integrity of the seal may be performed using the method according to the first or second aspects of the present invention.

The method may comprise varying the predetermined time period and/or the predetermined temperature and/or the predetermined force used in the bonding step, using a feedback loop, based upon the results obtained from the step of verifying the seal integrity. The method may comprise increasing the predetermined time period and/or the predetermined temperature and/or the predetermined force in response to the detection of an improper seal.

According to a fifth aspect of the present invention, there is provided a container sealed in accordance with the method defined in the fourth aspect of the present invention.

According to a sixth aspect of the present invention, there is provided a container assembly comprising a container, a sealing film locatable on the container to seal material in the container, a sealing region being defined between the container and the sealing film, wherein either one or both of the container or the sealing film includes a predetermined feature in the sealing region, an integral seal between the container and the sealing film being indicated when said predetermined feature is non-detectable, and an improper seal between the container and the sealing film being indicated when said predetermined feature is detectable.

The predetermined feature may be provided on the container and may extend entirely around the sealing region. Alternatively or in addition, the predetermined feature may be provided on the sealing film and may extend across the whole of the sealing film.

The predetermined feature may be an aspect of the surface configuration of the container and/or the film. The predetermined feature may comprise indentations in the surface of the sealing film and/or the container. The indentations may be parallel to each other and may be in the form of grooves or striations or scorings in the surface.

The container and/or the sealing film may comprise plastics material, and the indentations may be formed by localised melting of the surface of the plastics material. Alternatively the indentations may be formed during manufacture of the container and/or the sealing film.

The predetermined feature may comprise surface projections formed by the application of material to the surface of the container and/or the sealing film. The surface projections may comprise a plurality of ridges and may be printed onto the container and/or the sealing film.

The predetermined feature may be a repeating feature and may have a known period. The predetermined feature may be a repeat pattern.

The presence or absence of the predetermined feature may be detectable by the human eye or alternatively using image capture means.

The container may be used in the method according to the first, second or fourth aspects of the present invention.

According to a seventh aspect of the present invention, there is provided a method of sealing material in a container of a container assembly according to the sixth aspect of the present invention, the method comprising applying the sealing film to the container in the sealing region, and sealing the container by bonding the sealing film to the sealing region.

Embodiments of the present invention will now be described by way of example only and with reference to the accompanying drawings, in which;—

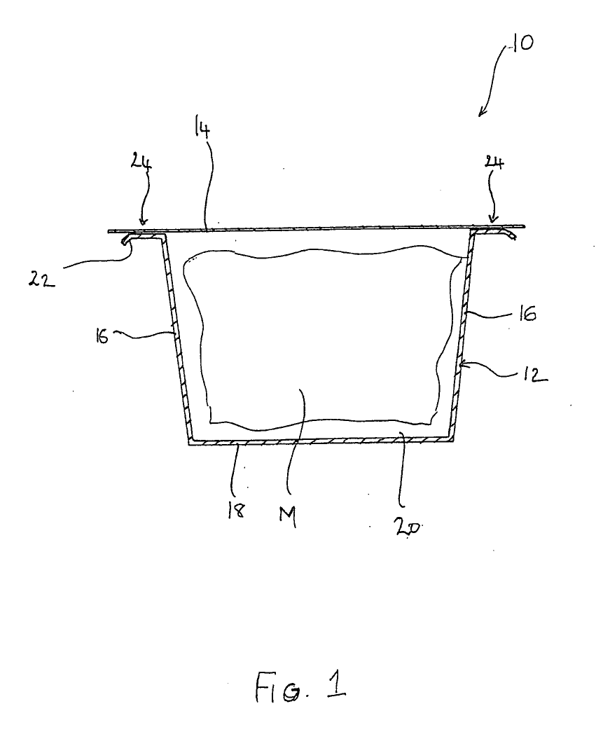

FIG. 1 is a diagrammatic cross-sectional side view of a container assembly according to the invention;

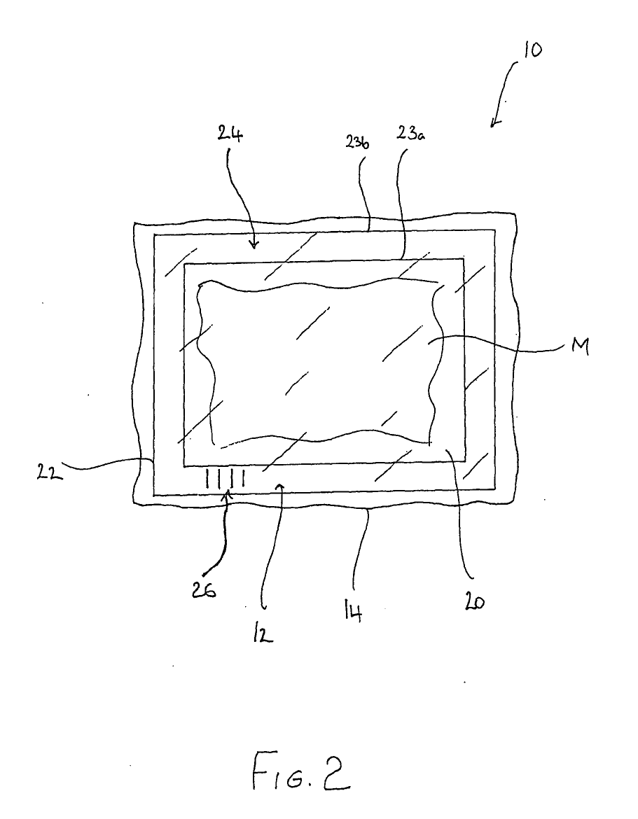

FIG. 2 is a top view of the assembly of FIG. 1;

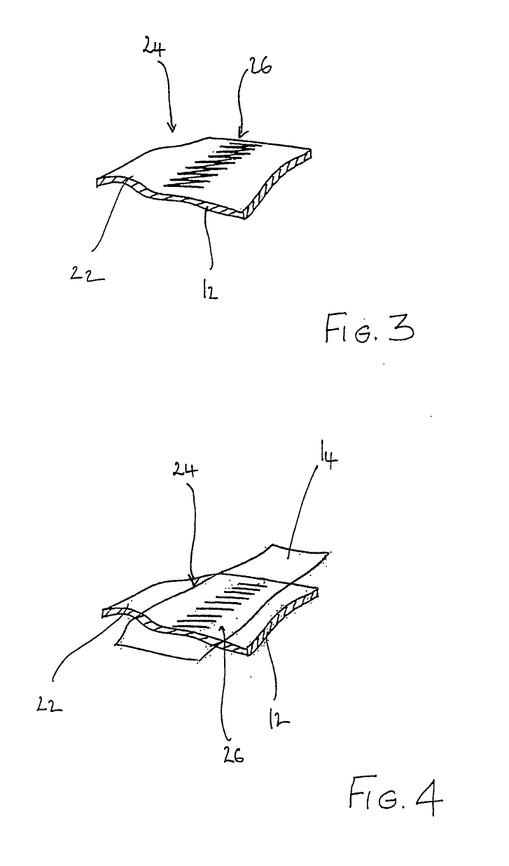

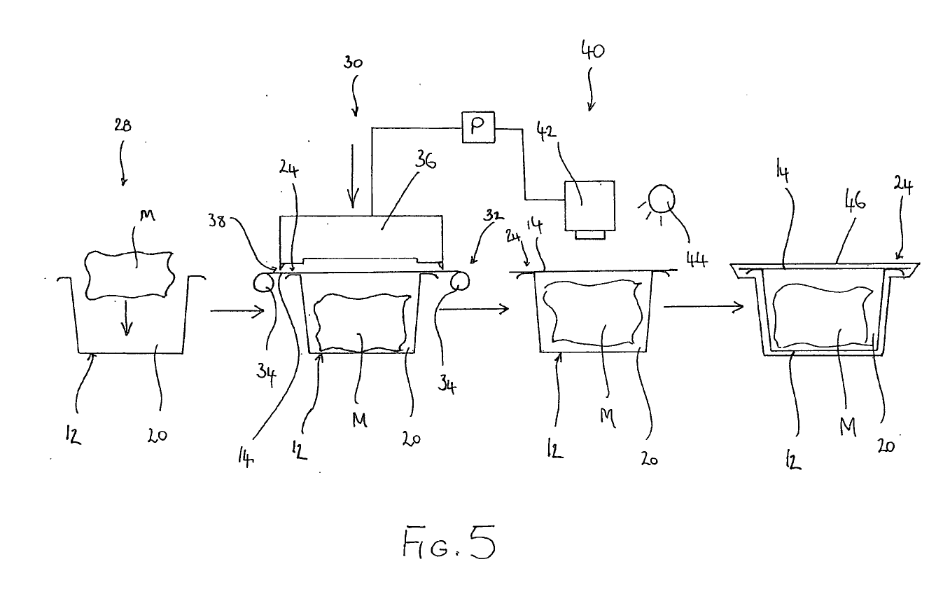

FIGS. 3 and 4 are enlarged perspective views of part of a peripheral sealing region of the container of the assembly of FIGS. 1 and 2; and

FIG. 5 is a diagrammatic view of a method and apparatus for sealing material in a container of the container assembly of FIGS. 1 and 2.

Referring to FIG. 1, there is shown generally a container assembly 10 comprising a container 12 and a sealing film 14 locatable on the container 12 to seal material M in the container. The container 12 is particularly Intended for receiving material M in the form of a pre-prepared food product, and in a preferred embodiment comprises amorphous or crystalline Polyethylene Terephthalate (PET) plastics material. Any other suitable material may however be used.

The container 12 has side walls 16 and a base 18 that define a cavity portion in the form of a cavity 20 in which the material M is locatable. A lip 22 extends around the upper end of the side walls 16 and defines a peripheral sealing region 24. The sealing film 14 is bonded to the container 12 in the peripheral sealing region 24 to seal the material M in the container 12.

The sealing film 14 also comprises a plastics material, for example PET plastics material, which is substantially transparent in at least the peripheral sealing region 24 so that the peripheral sealing region 24 of the container 12 is visible through the sealing film 14. Generally, the sealing film 14 is wholly transparent so that the container 12 and also its contents are visible through the sealing film 14. The sealing film 14 is bonded to the container 12 by the application of heat and/or pressure in the sealing region 24, as will be explained in more detail later.

In one form, the sealing film 14 may comprise a single layer of plastics material and may carry an adhesive material which is melted upon application of heat and which subsequently cures to bond the sealing film 14 to the container 12. In an alternative form, the sealing film 14 may comprise a plurality of layers of plastics material, one or more of which is melted and subsequently cures to bond the sealing film 14 to the container 12.

Referring also to FIGS. 2 to 4, the container 12 includes a predetermined feature 26 which extends completely around the sealing region 24. Although in the illustrated embodiment the predetermined feature 26 is provided on the container 12, it may alternatively or additionally be provided on the sealing film 14. When the predetermined feature 26 is provided on the sealing film 14, it may extend across the entirety of the film 14 rather than just being provided in the area corresponding to the sealing region 24.

The predetermined feature 26 comprises a predetermined aspect of the configuration of the surface of the container 12 and/or the sealing film 14. In preferred embodiments, the predetermined feature 26 is defined by an aspect of surface relief of the container 12 and/or of the sealing film 14 which is minor in comparison to the overall dimensions of the container 12.

According to one embodiment, the predetermined feature 26 may be defined by the absence of material from the surface of the container 12 and/or the sealing film 14 in the sealing region 24, and may comprise a plurality of indentations in the surface of the container 12 and/or the sealing film 14. The indentations may be parallel to each other and extend across the sealing region 24 between inner and outer edges 23a, 23b of the sealing region 24. For example, the indentations may have a depth in the order of approximately 20 μm and may be in the form of grooves or scorings or striations in the surface of the container 12. The depth of the indentations should not be so great as to prevent the formation of an integral seal between the container 12 and the sealing film 14.

The predetermined feature 26 may be formed during manufacture of the container 12, for example by an injection moulding or thermoforming process.

Alternatively, the predetermined feature 26 may be formed after the container 12 has been manufactured using a laser to provide localised ablation of an upper, amorphous, layer of the PET material from which the container 12 is preferably formed.

According to a different embodiment, the predetermined feature 26 may be defined by the presence of material on the container 12 and/or the sealing film 14 in the sealing region 24. For example, material may be applied to the container 12 and/or the sealing film 14 by printing to form a plurality of surface projections in the form of ridges or strips of the material. By way of example, a laser jet or an ink jet printing technique may be used to apply the material.

According to a preferred embodiment of the invention, the predetermined feature 26 is in the form of a repeat pattern which has a known predetermined repeatability and periodicity. For example, where the pattern comprises a plurality of indentations or surface projections, these may be of identical width and may be repeated at equally spaced intervals along the sealing region 24. For example, they may be repeated at distance intervals of approximately 1 mm. It will be appreciated however that any repeat distance may be chosen according to the desired resolution at which seal integrity is to be verified.

Alternatively, the spacing between the indentations or surface projections may be constant and the width of the indentations or surface projections varied to provide a periodic pattern.

In both cases, the period of the pattern (f) is known and predetermined, and is applied to the container 12 and/or the sealing film 14 according to the function y=f(x), where y is the spacing between adjacent indentations or surface projections, or alternatively the width of the indentations or surface projections, and x is the distance along the sealing region 24.

Whilst not essential to the invention, the provision of a periodic repeat pattern 26 is particularly advantageous since it enables automatic processing using a digital signal processing technique to verify seal integrity, as will be explained in detail later.

Prior to location of the sealing film 14 on the container 12 to seal the material M in the container 12, the predetermined feature 26 is fully visible around the entirety of the sealing region 24. Once the sealing film 14 has been bonded to the container 12, as shown in part in FIG. 4, at least the peripheral sealing region 24 of the container assembly 10 is viewed. An integral seal between the container 12 and the sealing film 14 is indicated if the presence of the predetermined feature 26 is no longer detectable around the entire sealing region 24. Conversely, an improper seal between the container 12 and the sealing film 14 is indicated if the presence of the predetermined feature 26 is detectable at any portion of the sealing region 24, as illustrated in FIG. 4.

It is believed that a change in the optical characteristics in the sealing region causes the presence of the predetermined feature 26 to be non-detectable when a proper, integral, seal has been formed between the container 12 and the sealing film 14, and to be detectable when an improper seal has been formed, as will now be explained.

Prior to application of the sealing film 14 to the container 12, the sealing region 24 of the container 12 has a first optical characteristic which may be defined by strong and weak reflective portions. The strong reflective portions provide a high amount of reflection of the incident light, and the weak reflective portions provide a low amount of reflection of the incident light.

Typically, the predetermined feature 26 scatters light and corresponds to the weak reflective portions, whilst the strong reflective portions may correspond to the portions of the container 12 without the predetermined feature 26.

It is these differences in the reflective characteristics between the strong and weak reflective portions which enable the presence of the predetermined feature 26 to be readily detected prior to application of the sealing film 14 to the container 12.

Once the sealing film 14 has been applied to the container 12 by bonding, the sealing region 24 of the container 12 has a second optical characteristic which determines the detectability of the presence of the predetermined feature 26.

At those portions of the sealing region 24 where a proper, integral, seal has been established between the container 12 and the sealing film 14, there will be no air interface between the container 12 and the sealing film 14. As the electrical permittivity/optical density of the sealing film 14 is closer to that of the container 12 than air, the amount of reflectance and hence scattering from the predetermined feature 26 is less. The second optical reflective characteristic is such that the amount of light reflected is below a predetermined threshold and the predetermined feature 26 is not detectable.

On the other hand, at those portions of the sealing region 24 where an improper seal has been formed, there will be an air interface between the container 12 and the sealing film 14, and the optical reflective characteristic is such that the amount of reflected light is above a predetermined threshold and the presence of the predetermined feature 26 is detectable at those portions. The predetermined threshold value may be determined experimentally, according to the particular circumstances.

The change in the optical characteristics described above may be caused by a change in the optical interface between the container 12 and the sealing film 14. For example, in the case of a container 12 in which the predetermined feature 26 is in the form of indentations formed using a laser, the applicant believes that bubbles may be formed on the exposed surface of the indentations during ablation, and these are believed to provide the ablated amorphous layer of PET material, from which the container 12 is preferably formed, with a high index of refraction such that incident light is reflected strongly at an air-container interface. This renders the indentations easily visible prior to application of the sealing film 14 to the container 12.

After application of the sealing film 14 to the container 12 by bonding, the intimate contact between the sealing film 14 and the container 12 in the sealing region 24, when a proper, integral, seal has been formed, is believed to cause the incident light to be reflected from the upper surface of the sealing film 14, rather than the interface between the sealing film 14 and the container 12. This renders the indentations invisible. However, if there is an improper bond, and hence an air interface, between the container 12 and the sealing film 14 at any portion of the sealing region 24, it is believed that the incident light is reflected by the indentations at the air-container interface, thus rendering them visible.

A method of sealing material M in the container assembly 10 according to the invention will be described with particular reference to FIG. 5. Firstly, an empty container 12 is provided and moved to a material loading station 28 in which the material M is loaded into the cavity 20 in the container 12. Depending upon the particular circumstances, the material M may be loaded by a manual operation or may alternatively be loaded using an automated process. The material M may be loaded in a single step, as illustrated, or may be loaded in a plurality of discrete steps. This is likely to be the case when the material M is a food product since the use of different constituents is likely to be necessary to provide the final desired food product.

Once the material M has been loaded into the cavity 20, the container 12 is moved to a sealing station 30 in which the material M is sealed in the container 12. The sealing station 30 includes a sealing film handling mechanism 32 which moves the sealing film 14 towards the container 12 and urges it into contact with the container 12 in the sealing region 24. The film handling mechanism 32 comprises a pair of rollers 34 between which the sealing film 14 is held taught, the rollers 34 being movable towards and away from the container 12 to move the sealing film 14 held therebetween, as required.

Once the sealing film 14 has been urged into contact with the container 12 by the film handling mechanism 32, a sealing head 36 is moved towards the container 12 and into contact with the sealing film 14 in the sealing region 24. The sealing head 36 is pressed against the sealing film 14 so that it applies a predetermined force to the sealing film 14 and the container 12 in the sealing region 24. Heating elements (not shown) are then activated to heat the sealing head 36 to a predetermined temperature and thereby heat the sealing film 14 and the container 12 in the sealing region 24 to bond the sealing film 14 to the container 12. The sealing head 36 is maintained in contact with the film 14 for a predetermined time period to achieve the desired bonding.

During the bonding step, as the temperature in the sealing region 24 is raised by the sealing head 36, the adhesive on the sealing film 14 melts and, as the temperature is lowered, subsequently cures to thereby bond the sealing film 14 to the container 12. Alternatively, if the sealing film 14 is a multi-layer film which does not carry an adhesive, one or more of the layers of the film 14 may melt and subsequently cure as the temperature is raised and lowered, thereby bonding the film 14 to the container 12. In addition to melting and subsequent curing of the adhesive or the sealing film 14, there may also be some localised melting and subsequent curing of the container material in the sealing region 24, as discussed above. This may assist with bonding the sealing film 14 to the container 12.

As an alternative to the sealing head 36, a laser (not shown) may be used to bond the sealing film 14 to the container 12. The laser is used to heat the sealing film 14 and container 12 in the sealing region 24, and sweeps around the sealing region 24 to effect the bonding. Depending on the power of the laser, a plurality of sweeps around the sealing region 24 may be needed to ensure bonding. Since in this case there would be no force applied to the sealing film 14 other than by the film handling mechanism 32, it may be desirable to preheat the container 12 in the sealing region 24 prior to application of the film 14, and this can be achieved by simply sweeping the laser around the sealing region 24 prior to application of the sealing film 14 thereto. This preheating step softens the container material and facilitates the bonding process.

It will be appreciated by those skilled in the art that instead of sweeping the laser around the sealing region 24 of the container 12, the laser may instead be stationary and the container 12 moved relative to the laser to heat the container 12 and the sealing film 14 in the sealing region 24.

Once the bonding step has been completed, the sealing film 14 is trimmed to remove any significant overlap beyond the outer edge of the sealing region 24. Where the sealing head 36 is used, this may include a peripheral cutter 38 which mechanically cuts the sealing film 14. Where a laser is used to cause bonding, the laser may be repositioned and the laser beam refocused so that it is capable of completely melting the sealing film 14. The laser may then be passed around the outboard edge of the sealing region 24 to thereby cut the sealing film 14, as required, or alternatively the container 12 moved relative to a stationary laser.

Whilst the method has thus far been described with reference to only one container 12, it should be appreciated that under normal circumstances, an array of containers 12 is simultaneously sealed in the sealing station 30. In this case, a single sheet of sealing film 14 may be simultaneously bonded to a plurality of containers 12, and the sealing head 36 may cut the sealing film 14 between adjacent containers 12 so they can be separated. In this case, the step of trimming the sealing film 14 is only performed on the containers 12 around the edge of the array.

After the sealing film 14 has been cut, the container assembly 10 is moved to a seal verification station 40 in which the integrity of the seal between the container 12 and the sealing film 14 formed by the bonding step in the sealing station 30 is verified.

The seal verification station 40 includes an image capture means in the form of a digital camera 42 which is used to capture an image of at least the sealing region 24 of the container assembly 10. Illumination means 44 are provided to illuminate the container assembly 10 so that a sufficiently clear image can be captured. In the preferred embodiment of the invention, the camera 42 is a line scan camera which is operable to capture an image of the entire surface of the container assembly 10 by scanning the assembly 10. The camera 42 is connected to a processor P which is operable to analyse the image captured by the camera 42 using a digital signal processing technique, as will now be described.

Once the image of the whole container assembly 10 has been captured, the processor P firstly extracts the image corresponding to the entire sealing region 24. The processor P then selects a plurality of sampling lines, for example between 5 and 10, generally parallel to the inner and outer edges 23a, 23b of the sealing region 24, the lines extending along the length of the sealing region 24 corresponding to one edge of the container 12. The sampling lines may be spaced generally equally across the sealing region 24 between the inner and outer edges 23a, 23b.

The processor P then samples the captured image by scanning the brightness values of individual pixels which form the image along each of the sampling lines. A suitable sampling frequency must be selected, and this is chosen as a function of the period of the periodic repeat pattern such that the detection of the presence of the pattern is possible at any portion of the sealing region 24.

The processor P then analyses the brightness values along each of the sampling lines using an appropriate transform, for example a fast Fourier or a Wavelet transform, to detect the presence of a predetermined characteristic signal spectrum provided by the periodic and discrete nature of the markings forming the repeat pattern.

These steps are repeated in the sealing region 24 along each of the other edges of the container 12.

There may be three conditions in which an improper seal is formed between the container 12 and the sealing film 14, and which may affect the measurable parameters of the predetermined characteristic signal spectrum.

The first of these conditions may be when there is a generally uniform improper seal around the entire sealing region 24 which has been caused by the selection of unsuitable sealing parameters in the sealing station 30, for example an unsuitable predetermined temperature and/or predetermined force and/or predetermined time period when the sealing head 36 is employed, or an unsuitably configured laser where a laser is employed.

The second of these conditions may be when there is an improper seal around a large portion of the sealing region 24, for example caused by poor handling of the sealing film 14 which has caused wrinkling of the sealing film 14 or poor contact between the sealing film 14 and the surface of the container 12 in the sealing region 24.

The third of these conditions may be when there is an improper seal at a localised portion of the sealing region 24, for example caused by localised contamination between the container 12 and the sealing film 14. Where the material M is a food product, accidental deposition of the food product in the sealing region 24 may cause such localised contamination.

In order to deal with the first or second of these conditions, a fast Fourier transform may be applied to the sampling lines. Parameters based on the Fourier transform, for example the amplitude of the main frequency components and the entropy of the Fourier amplitude, may characterise the seal quality. In the case of an improper seal between the container 12 and the sealing film 14, the main peak amplitude of the fast Fourier transform may be greater than a predetermined threshold value, and the entropy of the main peak amplitude may be lower than a predetermined threshold value.

In order to establish a set of criteria which may be used to assess the integrity of the seal, an artificial neural network may be created and a large amount of data from captured images of both good and bad seals may be tested.

In order to deal with the third of these conditions, a Wavelet transform may be applied to the sampling lines to decompose the sampling lines, and the application of such a transform will simultaneously provide information in both spatial and spatial-frequency domains. A localised defect in the sealing region 24, such as experienced in the third condition, would alter the embedded frequency information in the repeat pattern, and the extent and location of the localised defect in the seal would be manifested in the wavelet coefficients as a localised peak. In contrast, an integral seal would be manifested as a generally uniform wavelet spectrum.

In the event that the processor P detects the presence of an improper seal, in other words a non-integral seal, between the container 12 and the sealing film 14 in the sealing region 24, an alert, audible, visual or otherwise, may be provided by the seal verification station 40. The improperly sealed container 12 may also be rejected by the seal verification station 40.

The processor P may form part of a continuous feedback loop with the sealing station 30 so that the temperature and/or force applied by the sealing head 36, and/or the time period for which each is applied, and/or the parameters of the sealing film handling mechanism 32, such as the film tension or height settings, may be varied in real time in response to the detection of an improper seal. For example, if the presence of the predetermined period of the periodic pattern, and hence an improper seal, is detected at any portion of the sealing region 24, the processor P may increase the temperature and/or force applied by the sealing head 36 and/or increase the predetermined time period.

Where a laser is used instead of the sealing head 36, parameters such as the laser power, number of sweeps around the sealing region 24 and sweep speed may be altered to ensure proper sealing between the container 12 and the sealing film 14.

The provision of such a continuous feedback loop is particularly advantageous since although the parameters of the sealing head 36 or laser which affect bonding may be initially optimised to achieve an integral seal between the container 12 and the sealing film 14, the formation of the seal during the bonding step may be affected by changes in ambient temperature, and the like.

In the event that the processor P does not detect the presence of the known predetermined period of the pattern, this indicates that an integral seal has been formed. The sealed container assembly 10 can then be subjected to a final packaging stage, for example by the application of an outer cardboard sleeve 46. If the material M loaded into the cavity 20 is a hot food product, the sealed container assembly 10 may also be subjected to a chilling operation to reduce the product temperature before the sleeve 46 is applied.

In the preferred embodiment of the invention, the loading station 28, sealing station 30 and seal verification station 40 all form part of a packaging machine which is arranged to simultaneously process an array of container assemblies 10 according to the invention.

Although embodiments of the invention have been described in the preceding paragraphs with reference to various examples, it should be appreciated that various modifications to the examples given may be made without departing from the scope of the present invention. For example, the sealing region 24 or an image of the sealing region 24 may be viewed by the human eye to thereby detect the presence or absence of the pattern 26 in the sealing region 26. The container 12 may be of any shape or configuration, provided that an identifiable sealing region 24 is defined between the container 12 and the sealing film 14. Any suitable transform other than a fast Fourier or Wavelet transform may be employed to perform the frequency analysis. Any number of sampling lines may be selected. Any suitable means other than a sealing head 36 or laser may be employed in the sealing station 30 to bond the sealing film 14 to the container 12. Any suitable sealing film handling mechanism 32 may be utilised. Where the predetermined feature is a repeat pattern, it may repeat at any suitable interval to permit the integrity of the seal to be verified.

Whilst endeavouring in the foregoing specification to draw attention to those features of the invention believed to be of particular importance, it should be understood that the Applicant claims protection in respect of any patentable feature or combination of features hereinbefore referred to and/or shown in the drawings, whether or not particular emphasis has been placed thereon.

1-68. (canceled)

69. A method of verifying the integrity of a seal in a sealing region between a container and a sealing film applied to the container, the presence of a detectable predetermined feature in the sealing region being indicative of an improper seal between the container and the sealing film, the method comprising viewing at least the sealing region to detect the presence of the predetermined feature in the sealing region.

70. A method according to claim 69, wherein the absence of a detectable predetermined feature is indicative of an integral seal between the container and the sealing film, and the method comprises viewing at least the sealing region to detect the presence or absence of the predetermined feature in the sealing region.

71. A method according to claim 69, wherein the step of viewing at least the sealing region comprises viewing the entire sealing region to detect the presence of the predetermined feature at any portion of the sealing region.

72. A method according to claim 69, wherein the step of viewing the sealing region comprises viewing the sealing region using the human eye.

73. A method according to claim 69, wherein the step of viewing the sealing region comprises capturing an image of the sealing region using image capture means.

74. A method according to claim 73, wherein the step of viewing the sealing region comprises capturing an image of the container and the sealing region, and extracting the image of the sealing region.

75. A method according to claim 73, wherein the method comprises processing the captured image to detect the presence of the predetermined feature at any portion of the sealing region.

76. A method according to claim 75, wherein where the predetermined feature has a known period, the processing step comprises processing the captured image to detect the existence of the known period in the image.

77. A method according to claim 75, wherein where the predetermined feature has a predetermined characteristic signal spectrum, the processing step comprises processing the captured image to detect the presence of the predetermined characteristic signal spectrum.

78. A method according to claim 75, wherein a fast Fourier transform or a Wavelet transform is used to perform the processing step.

79. A method according to claim 75, wherein the processing step is provided by a computer program.

80. A method according to claim 76, wherein the method comprises providing an alert in response to the detection of the known period or the predetermined characteristic signal spectrum by the processing step.

81. A method according to claim 69, wherein the predetermined feature is a feature of the container and/or of the sealing film.

82. A method according to claim 81, wherein the predetermined feature is an aspect of surface configuration of the container and/or of the sealing film.

83. A method according to claim 82, wherein the predetermined feature is an aspect of minor surface relief compared to the overall dimensions of the container.

84. A method according to claim 81, wherein the predetermined feature is defined by material applied to the surface of the container and/or the sealing film in the sealing region.

85. A method according to claim 84, wherein the material is applied using a printing technique to provide surface projections.

86. A method according to claim 81, wherein the predetermined feature comprises the absence of material from the surface of the container and/or the sealing film in the sealing region.

87. A method according to claim 86, wherein the absence of material forms indentations.

88. A method according to claim 87, wherein the indentations are formed during manufacture of the container and/or the sealing film.

89. A method according to claim 88, wherein the indentations are formed by removal of material from the surface of the container and/or the sealing film.

90. A method according to claim 69, wherein the predetermined feature has some aspect of repeatability.

91. A method according to claim 90, wherein the predetermined feature comprises a plurality of spaced indentations or surface projections and the spacing between the indentations or projections has a predetermined periodicity.

92. A method according to claim 90, wherein the predetermined feature comprises a plurality of spaced indentations or surface projections and a characteristic of the indentations or surface projections is predetermined.

93. A method according to claim 92, wherein the predetermined characteristic is the width of the indentations or projections.

94. A method according to claim 90, wherein the predetermined feature is a repeat pattern and repeats at intervals of up to 2 mm.

95. A method according to claim 94, wherein the repeat interval allows the integrity of the seal to be verified over that interval, and is selected to enable automated processing using a digital signal processing technique.

96. Apparatus for verifying the integrity of a seal in a sealing region between a container and a sealing film applied to the container, the presence of a detectable predetermined feature in the sealing region being indicative of an improper seal between the container and the sealing film, the apparatus comprising image capture means for capturing an image of at least the sealing region and a processor for processing the captured image to detect the presence of a predetermined feature in the sealing region.

97. Apparatus according to claim 96, wherein the image capture means includes a camera operable to capture an image of the sealing region.

98. Apparatus according to claim 97, wherein the camera is a line scan camera.

99. Apparatus according to claim 96, wherein the apparatus includes illumination means for illuminating the container in at least the sealing region.

100. Apparatus according to claim 97, wherein the processor is operable to analyze the image captured by the camera to detect the presence of the predetermined feature in the image.

101. Apparatus according to claim 96, wherein the apparatus is used to perform the method according to claim 69.

102. A method of sealing material in a container, the container including a cavity portion for receiving material and a peripheral sealing region, the method comprising applying a sealing film to the container in the sealing region to cover the cavity portion, and sealing the container by bonding the sealing film to the peripheral sealing region, wherein a detectable predetermined feature at a portion of the sealing region indicates an improper bond between the container and the sealing film.

103. A method according to claim 102, wherein the method comprises locating material in the cavity portion of the container prior to applying the sealing film.

104. A method according to claim 102, wherein the step of applying the sealing film comprises urging the sealing film and the container towards each other.

105. A method according to claim 102, wherein the method comprises heating the container in the peripheral sealing region prior to applying the sealing film to soften the container material.

106. A method according to claim 102, wherein the bonding step comprises causing melting of an adhesive on the sealing film and subsequently allowing curing of the adhesive.

107. A method according to claim 102, wherein the bonding step comprises causing localized melting of the container and/or the sealing film and subsequently allowing curing thereof.

108. A method according to claim 102, wherein the bonding step comprises heating and/or applying a force to the sealing film and the container in the peripheral sealing region.

109. A method according to claim 108, wherein the bonding step comprises heating and/or applying the force for a predetermined time period.

110. A method according to claim 108, wherein the bonding step comprises heating to a predetermined temperature and applying a predetermined force.

111. A method according to claim 108, wherein a sealing head is used to heat and/or apply the force to the sealing film and the container, and the bonding step comprises pressing the sealing head against the sealing film and activating a heating element to heat the sealing head.

112. A method according to claim 108, wherein a laser is used to heat the sealing film and/or the container in the peripheral sealing region, and the bonding step comprises activating the laser and sweeping the activated laser around the peripheral sealing region.

113. A method according to claim 102, wherein the method comprises trimming the bonded sealing film after bonding to the container so that there is substantially no overlap of sealing film beyond the peripheral sealing region.

114. A method according to claim 102, wherein the method comprises verifying the integrity of the seal in the sealing region between the container and the sealing film bonded to the container.

115. A method according to claim 114, wherein the method comprises varying the predetermined time period and/or the predetermined temperature and/or the predetermined force used in the bonding step, using a feedback loop, based upon the results obtained from the step of verifying the seal integrity.

116. A method according to claim 115, wherein the method comprises increasing the predetermined time period and/or the predetermined temperature and/or the predetermined force in response to the detection of an improper seal.

117. A container sealed in accordance with the method defined in claim 102.

118. A container assembly comprising a container, a sealing film locatable on the container to seal material in the container, a sealing region being defined between the container and the sealing film, wherein either one or both of the container and the sealing film includes a predetermined feature in the sealing region, an integral seal between the container and the sealing film being indicated when said predetermined feature is non-detectable, and an improper seal between the container and the sealing film being indicated when said predetermined feature is detectable.

119. A container assembly according to claim 118, wherein the predetermined feature is provided on the container and extends entirely around the sealing region.

120. A container assembly according to claim 118, wherein the predetermined feature is provided on the sealing film and extends across the whole of the sealing film.

121. A container assembly according to claim 118, wherein the predetermined feature is an aspect of the surface configuration of the container and/or the sealing film.

122. A container assembly according to claim 121, wherein the predetermined feature comprises indentations in the surface of the sealing film and/or the container.

123. A container assembly according to claim 122, wherein the indentations are parallel to each other and are in the form of grooves or striations or scorings in the surface.

124. A container assembly according to claim 122, wherein the container and/or the sealing film comprise plastics material, and the indentations are formed by localized melting of the surface of the plastics material.

125. A container assembly according to claim 122, wherein the indentations are formed during manufacture of the container and/or the sealing film.

126. A container assembly according to claim 118, wherein the predetermined feature comprises surface projections formed by the application of material to the surface of the container and/or the sealing film.

127. A container assembly according to claim 126, wherein the surface projections comprise a plurality of ridges printed onto the container and/or the sealing film.

128. A container assembly according to claim 118, wherein the predetermined feature is a repeating feature and has a known period.

129. A container assembly according to claim 118, wherein the predetermined feature is a repeat pattern.

130. A container assembly according to claim 118, wherein the presence or absence of the predetermined feature is detectable by the human eye or using image capture means.

131. A method of sealing material in a container of a container assembly according to claim 118, the method comprising applying the sealing film to the container in the sealing region, and sealing the container by bonding the sealing film to the sealing region.
